(19) United States
(12) Patent Application Publication
(10) Pub. No.: US 2008/0284592 A1
(43) Pub. Date: Nov. 20, 2008

(54) Home health monitoring system

(76) Inventors: Donald A. Collins, JR., Buford, GA (US); Keith R. Russell, Atlanta, GA (US)

Correspondence Address: DONALD ALEXANDER COLLINS, JR., 3785 CREEKVIEW RIDGE DRIVE, BUFORD, GA, 30518, US

(21) Appl. No.: 11/803,731

(22) Filed: May 16, 2007

(51) Int. Cl. G08B 13/00

(52) U.S. Cl. 340/541

(57) ABSTRACT

The present invention relates to a system and method of modifying and utilizing a standard home security system augmenting it into a viable state-of-the-art home health monitoring system. More specifically, this invention relates to an apparatus and method of adding a program and some motion sensors thus using the methods (with slight modification) of an existing home security system in such a way that there is a minimum of intrusion and cost compared to other methods.

### BACKGROUND

It would be desirable to provide a low cost Home Health Monitoring System to protect older people who are oftentimes living apart from their families.

Public Information Office, U.S. Census Bureau, RELEASED: 10:35 A.M. EST, THURSDAY, Mar. 9, 2006;

“The collection, analysis and reporting of reliable data are critical to informing policy as the nation moves ahead to address the challenges and opportunities of an aging population,” says NIA Director Richard J. Hodes, M.D. “This report tells us that we have made a lot of progress in improving the health and well-being of older Americans, but there is much left to do.”

“Among the trends:

The U.S. population age 65 and over is expected to double in size within the next 25 years. By 2030, almost 1-out-of-5Americans—some 72 million people—will be 65 years or older. The age group 85 and older is now the fastest growing segment of the U.S. population.

The health of older Americans is improving. Still, many are disabled and suffer from chronic conditions. The proportion with a disability fell significantly from 26.2 percent in 1982 to 19.7 percent in 1999. But 14 million people age 65 and older reported some level of disability in Census 2000, mostly linked to a high prevalence of chronic conditions such as heart disease or arthritis.

The financial circumstances of older people have improved dramatically, although there are wide variations in income and wealth. The proportion of people aged 65 and older in poverty decreased from 35 percent in 1959 to 10 percent in 2003, mostly attributed to the support of Social Security. In 2000, the poorest fifth of senior households had a net worth of $3,500 ($44,346 including home equity) and the wealthiest had $328,432 ($449,800 including home equity).

Florida (17.6 percent), Pennsylvania (15.6 percent) and West Virginia (15.3 percent) are the “oldest” states, with the highest percentages of people age 65 and older. Charlotte County, Fla., (34.7 percent) has the highest concentration of older residents and McIntosh County, N.D., (34.2 percent) ranks second.

Higher levels of education, which are linked to better health, higher income, more wealth and a higher standard of living in retirement, will continue to increase among people 65 and older. The proportion of Americans with at least a bachelor's degree grew five-fold from 1950 to 2003, from 3.4 percent to 17.4 percent; and by 2030, more than one-fourth of the older population is expected to have an undergraduate degree. The percentage completing high school quadrupled from 1950 to 2003, from 17 percent to 71.5 percent.

As the United States as a whole grows more diverse, so does the population age 65 and older. In 2003, older Americans were 83 percent non-Hispanic white, 8 percent black, 6 percent Hispanic and 3 percent Asian. By 2030, an estimated 72 percent of older Americans will be non-Hispanic white, 11 percent Hispanic, 10 percent black and 5 percent Asian.

Changes in the American family have significant implications for future aging. Divorce, for example, is on the rise, and some researchers suggest that fewer children and more stepchildren may change the availability of family support in the future for people at older ages. In 1960, only 1.6 percent of older men and 1.5 percent of women age 65 and older were divorced; but by 2003, 7 percent of older men and 8.6 percent of older women were divorced and had not remarried. The trend may be continuing. In 2003, among people in their early 60s, 12.2 percent of men and 15.9 percent of women were divorced.

The 65+ report is a project of the NIA's Behavioral and Social Research Program, which supports the collection and analyses of data in several national and international studies on health, retirement, and aging. The program's director, Richard M. Suzman, Ph.D., suggests that, with five years to go before the baby boom turns 65, “Many people have an image of aging that may be 20 years out of date. The very current portrait presented here shows how much has changed and where trends may be headed in the future . . . .

The percent of people 65 years and over living in nursing homes declined from 5.1 percent in 1990 to 4.5 percent in 2000. This percent decline occurred for people 65 to 74 years, 75 to 84 years, and especially in the population 85 years and over, where only 18.2 percent lived in nursing homes in 2000, compared with 24.5 percent in 1990. Ninety-one percent of the nursing home population was 65 years and over in 2000, compared with 90 percent in 1990. For a graph of this data, see FIG. 4.

The health of older Americans is improving. Still, many are disabled and suffer from chronic conditions. The proportion with a disability fell significantly from 26.2 percent in 1982 to 19.7 percent in 1999. But 14 million people age 65 and older reported some level of disability in Census 2000, mostly linked to a high prevalence of chronic conditions such as heart disease or arthritis.”

According to The MetLife Market Survey of Nursing Home & Home Care Costs, September 2006; The national average daily rate for a private room in a nursing home is $206, or $75,190 annually. The national average daily rate for a semi-private room in a nursing home is $183, or $66,795 annually. The national average hourly rate for home health aides is $19. The national average hourly rate for homemakers/companions is $17. Because of the cost, and negative effects of a nursing home, seniors in possession of adequate health, given the choice will almost always chose to remain at home.

Assuming seniors are at home until a higher age, it will be necessary to monitor their well being on an hourly basis. Many seniors are disinterest in technology or may have difficulty mastering the complexities of its use.

The Pew Internet Project's Susannah Fox, FTC: Protecting Consumers in the Next Tech-Age, “Internet Usage Trends—Through the Demographic Lens”, Nov. 6, 2006 “estimate(s) that 73% of adults in the U.S. go online . . . not true with people over age 65, of whom just 32% are online. If a senior is offline, they are probably what we call “Truly Disconnected.” They have never used the internet and do not live in a connected household. Many of these people say they don't even know anyone who goes online. If they needed to access information on a website, they would probably not know where to start.”

According to U.S. Census Bureau/Published in Housing Characteristics: 2000, there were 105,480,101 occupied housing units in the United States.

[Para 19] In 2006, Parks Associates, a Texas-based market research firm, suggests that the U.S. home security market is nearing maturation, with 21% of homes having adopted electronic security systems.

There are three major equipment suppliers in the U.S. security market; GE Security of, Minnesota, www.gesecurity.com; Honeywell Security & Custom Electronics, of New York, www.honeywell.com/security; and Digital Security Controls, of Toronto, Canada, www.dsc.com. The process described in this patent is not described in any of these companies' product offerings as of the writing of this application.

For a graphical description of the U.S. population and an immediate market for this patent is 22+ million households see FIGS. 2 & 3.

Market leader ADT, home security systems, suggests that it “protects more than 6 million homes from fire, flood, theft, CO and medical emergencies.”

### Patent Citation 1

U.S. Pat. No. 7,141,026

Nov. 28, 2006, Aminian, et al., invention includes a sensor to be attached to a trunk of a subject and relates to a system and a method for monitoring body movement, in particular but not exclusively for evaluating the falling risk and/or for monitoring sitting, standing, lying, walking and running periods. The system is characterized by the fact that it comprises means for determining the time of postural transition. The present invention requires no device to be attached to the subject.

### Patent Citation 2

U.S. Pat. No. 7,126,467

### Patent Citation 3

U.S. Pat. No. 7,129,833

Oct. 24, 2006, Albert , et al., describe a “method, system and device useful with conventional personal computers respond automatically to an identified alarm sound by sending a notification signal via the Internet only when a special sound monitoring program is active. Additionally, bedside detection of acoustic alarms is combined with enhanced waking devices to insure the waking of a child or hearing impaired person in response to an emergency. Home safety and security are provided using a bedside unit to monitor audible safety and security alarms and send notification signals to the appropriate communication site. A health monitoring method and system utilizes the bedside device to monitor breathing patterns and other health measuring signals and communicate these patterns and signals to a medical monitoring station.” The present invention doesn't utilize a personal computer.

### Patent Citation 4

U.S. Pat. No. 7,001,334

Feb. 21, 2006, Reed, et al., describes “an integrated subject monitoring system facilitates measurement, collection and analysis of data pertaining to the health status of a subject. The system includes a network-coupled computer and subsystems monitoring subject location within a defined space and the curtilage thereof and obtaining measurements of a subject's physiological or behavioral/cognitive parameters within the defined space. Parameter data is obtained primarily passively, without the cooperation or active participation of the subject. A method of monitoring the physiological and behavioral/cognitive health status of an ambulatory subject involves monitoring in a primarily passive fashion, irrespective of the active collaboration of the subject. Subject health indicia parameters are continuously monitored, sampled and recorded. Captured values are compared to initial baseline values established for each of the measured parameters as well as to the trend for the parameter of that subject. Readings falling outside the boundaries trigger a signal to be sent to an appropriate party.” This embodiment describes a nursing home environment with no security system. The present invention does not utilize a network connected computer.

### SUMMARY

A system for using a security system controller box hardware and software and motion sensors to monitor the health and well being of occupants within their residences.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 a floor plan of a typical 2 bedroom ranch style house showing some sensor locations

FIG. 2 Figure showing percentage of households in U.S. with security systems in 2004 and projected in 2009

FIG. 3 U.S. population 2003 by age and sex

FIG. 4 Nursing home residents by age and sex

FIG. 5 Process to upgrade a security system to home health system

FIG. 6 Occupant's movement inside of home health system

FIG. 7 Occupant trip 1 showing route for occupant movement inside house

FIG. 8 Initial route settings (before system learns occupant's habits)

FIG. 9 Final route settings (after system has learned occupant's habits)

### DETAILED DESCRIPTION

The safety and well being of our parents in their twilight years is of paramount importance to the children and demands a high level of attention to detail.

In accordance with the teachings of the present invention, a system and method of converting a home security system to be able to accommodate the home health monitoring system is provided.

It is accordingly an object of the present invention to provide the most trusted and foolproof electronic system and method of monitoring our parent(s) at home.

It is another object of the present invention to provide the most electronically traceable system and method of monitoring our parent(s) at home.

It is another object of the present invention to provide the most convenient and noninvasive electronic system and method for monitoring our parent(s) at home.

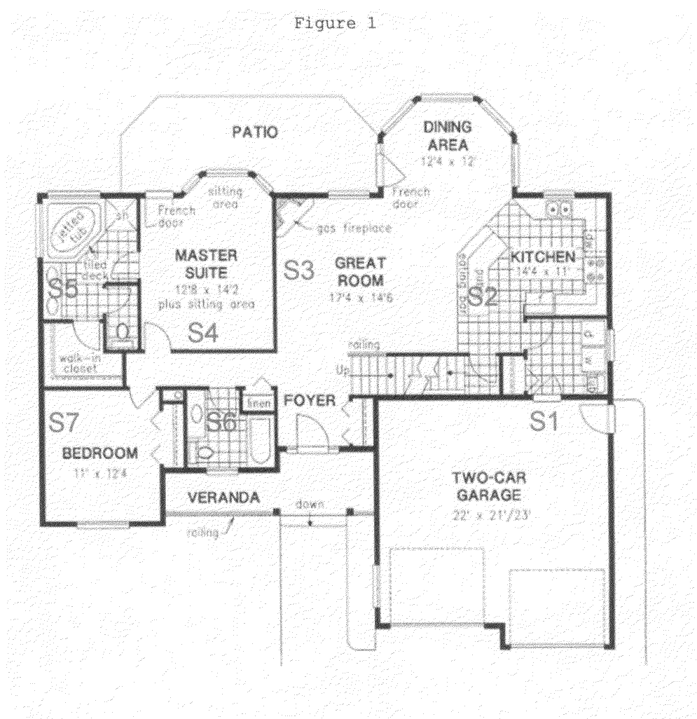

Referring now to FIG. 1, wherein is shown a floor plan of a typical Ranch style home. For the purpose of this invention description, this home is designated as our parent's home—either Mom or Dad or both.

In this example, there is a motion sensor Sx located in every room; S1 is door entry from garage; S2 is kitchen; S3 is great room; S4 is master bedroom; S5 is master bathroom; S6 is guest bathroom; S7 is guest bedroom; S8 is dining room

As the occupant travels around his/her house, every time they pass in front of (or dwells in front of) each motion sensor it is tripped and sends a signal to the controller, which measures the sensor trip time and sensor trip duration and notes each occurrence in its memory thereby creating a history of where the occupant has traveled throughout the house and the timing of each travel and stops.

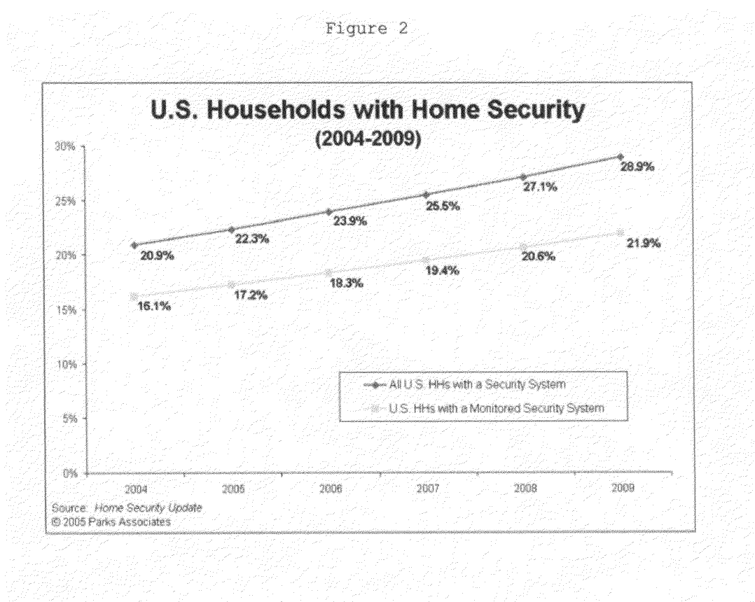

Referring now to FIG. 2, showing 2006, Parks Associates, a Texas-based market research firm, suggesting that the U.S. home security market is nearing maturation, with 21% of homes having adopted electronic security systems.

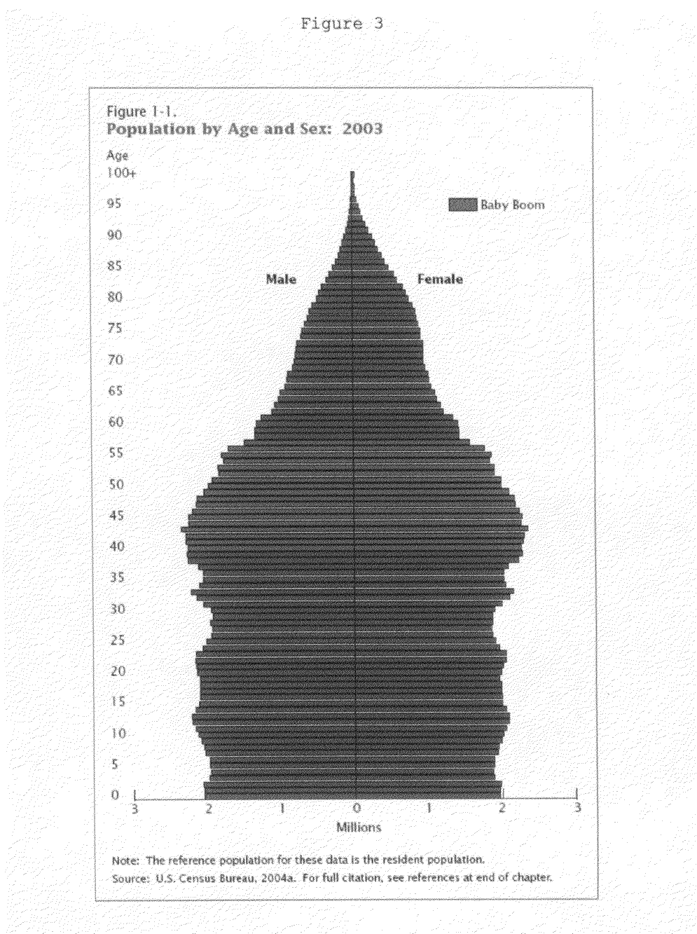

Referring now to FIG. 3, showing the population of the U.S. at the time of 2003 by age and gender. It also shows the bubble of baby boomers who will soon retire and be users of this invention.

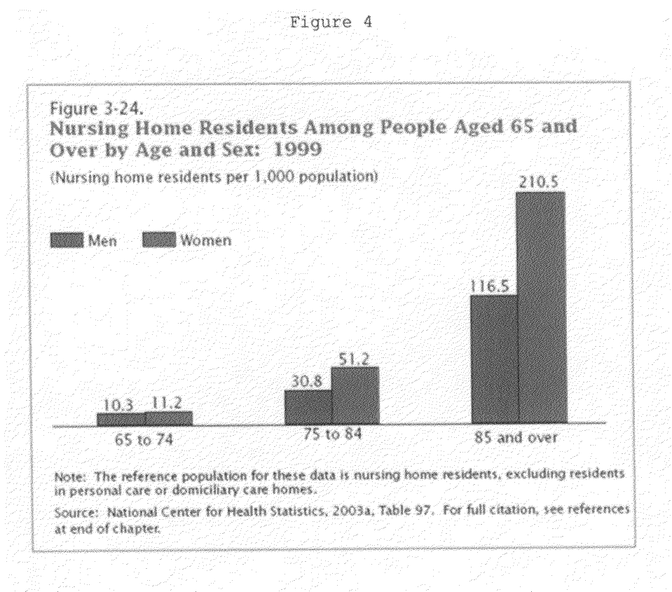

Referring now to FIG. 4, which shows the percent of people 65 years and over living in nursing homes in the U.S. by age and gender.

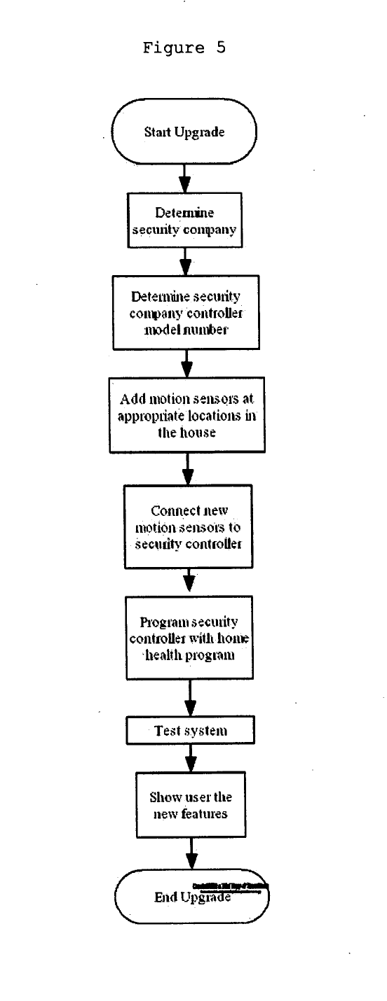

Referring now to FIG. 5, which shows a flowchart. This flowchart describes how an installer upgrades a typical security system to become a home health monitoring system by; 1) determining the security system company and then by; 2) determining the model of controller used by the security company and then by; 3) adding additional motion sensors marked S1-S8 as shown in FIG. 1 and then by; 4) connecting those motion sensors as they would normally be connected to the security system in the house and then by; 5) installing the home health software into the security system controller and then by; 6) testing the system to assure that it functions and then by; 7) educating the occupant about the home health system.

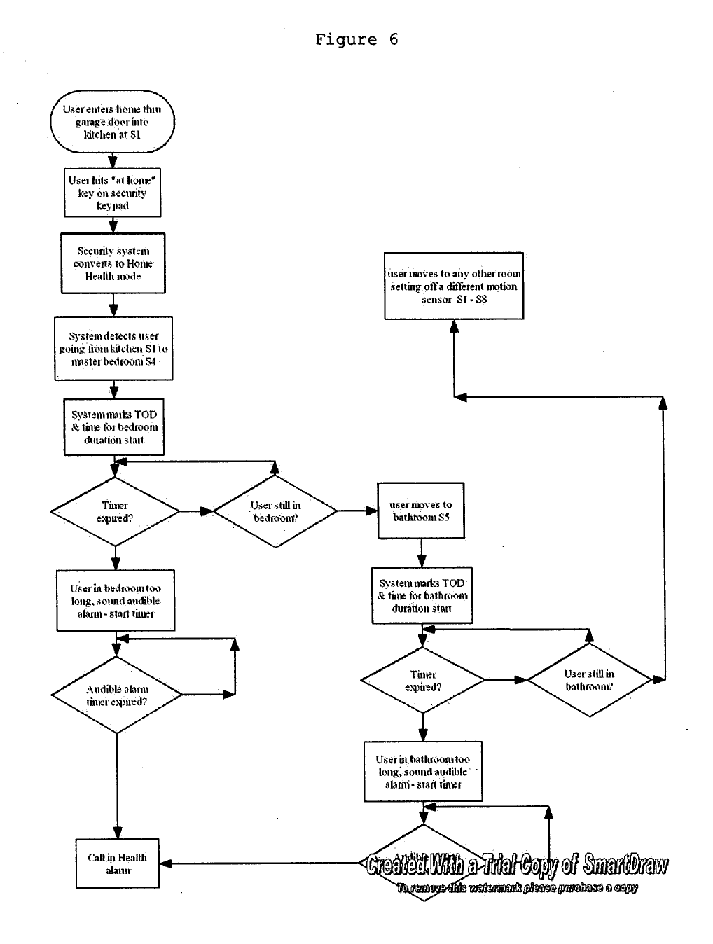

Referring now to FIG. 6, which shows the function of the home health monitoring system. It describes how the occupant enters the house and then travels through the kitchen, through the bedroom, to the bathroom where the occupant dwells for too long and generates a system alarm.

The home health software system functions by utilizing the security systems hardware and software in conjunction with motion sensors that detect the presence and movement of the occupant throughout the house.

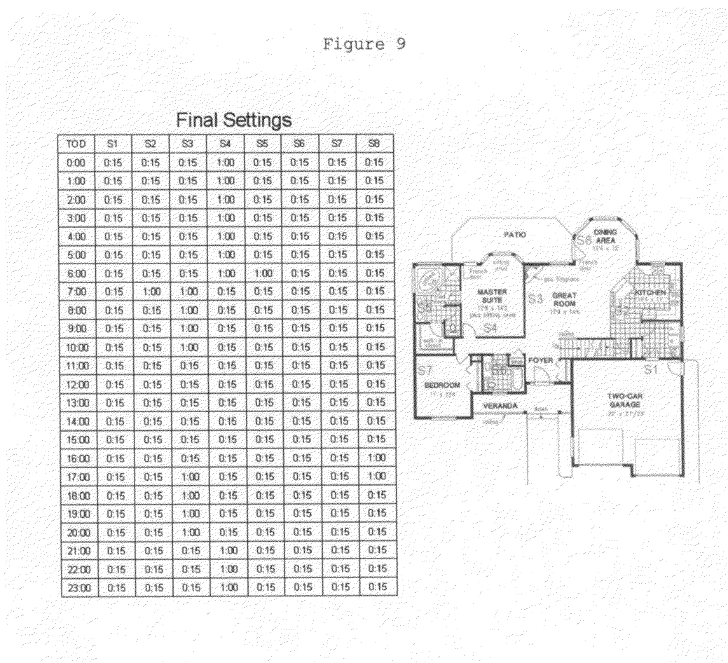

There are three modes for the system, initialization, learning, and armed mode. During learning mode, settings are derived from the occupant's travels and subsequently duration times are programmed into the security controller. The duration times (different for each room and time of day as shown in FIG. 9) define the length of time a occupant can stay in each room before an alarm is generated.

There are two types of alarms. First is a local audible alarm meant to get the attention of the occupant so that they can respond and extend the duration timer or disable the system for a preprogrammed time period. If there is no occupant response to the audible alarm within a preprogrammed time period, then the security (home health monitoring) system will generate a telephone call to the helpdesk.

The person receiving the call at the helpdesk will call the occupant at their home telephone to assess the gravity of the emergency directly from the occupant. The system may have generated a spurious or false alarm. If the occupant does not answer their telephone, then the helpdesk will review the occupant's most recent travels to determine where they are in the house, and the helpdesk will dispatch the police to the occupant's residence.

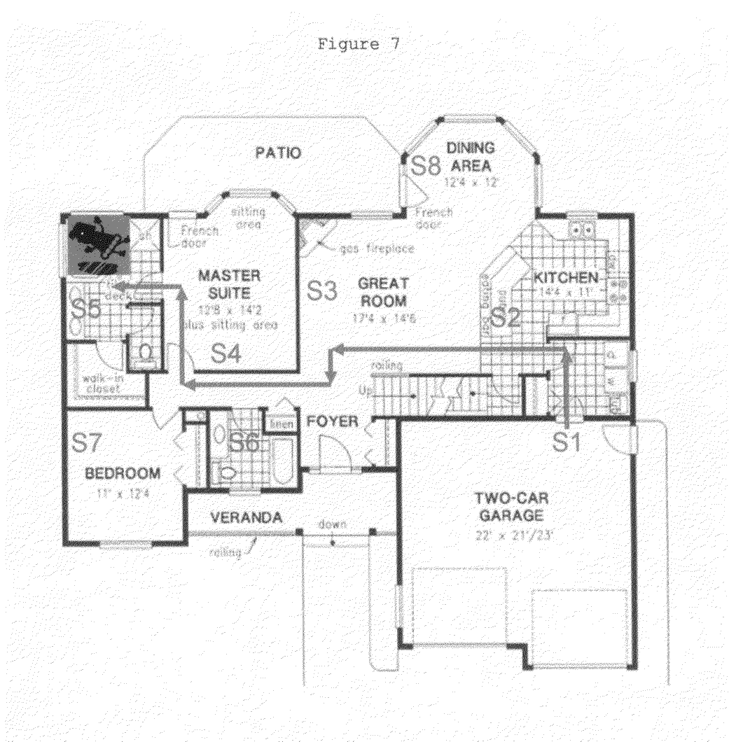

Referring now to FIG. 7, which shows an example path that the occupant might take from their garage to their master bathroom.

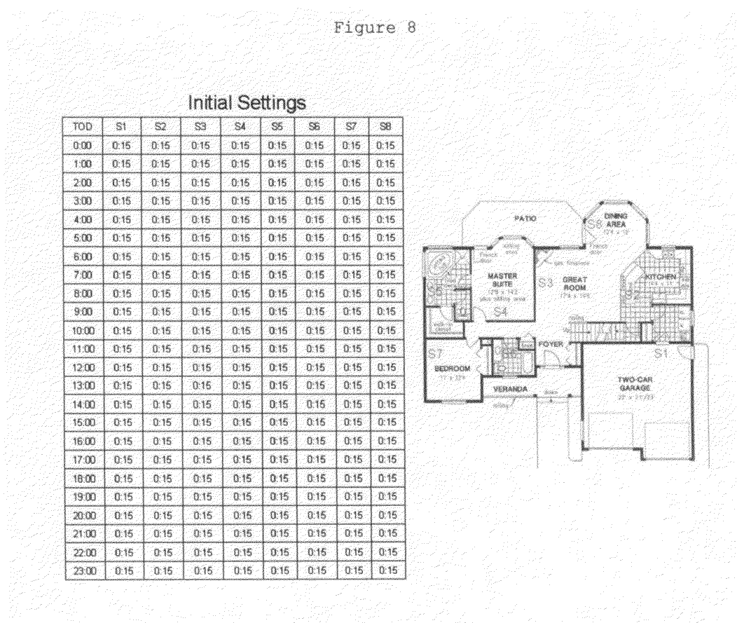

Referring now to FIG. 8, when initialized, prior to any occupant input, the home health monitoring system is defaulted to 15 minutes per sensor (room) for every hour of the day. Following the learning period, when the system is in arm mode, if a occupant dwells in a room (a cell in FIG. 9) for longer than the programmed time (in the cell of FIG. 9) then the system will generate an audible alarm and with no answer by the occupant at one of the keypads, then a subsequent alarm to the helpdesk.

Referring now to FIG. 9, once the home health monitoring system has learned the routines of the occupant with regard to his/her travels throughout the house and the timing of each, then the system can be armed. Once armed, if the occupant stays for example for more than 0:16 in the living room from 4 to 5pm any day, then the system will alarm. It may also be necessary to define different tables each for days of the week.

Although the invention has been described with particular reference to certain preferred embodiments thereof, variations and modifications of the present invention can be effected within the spirit and scope of the following claims. It is evident that those skilled in the art may now make numerous other uses and modifications of and departures from the specific embodiments described herein without departing from the inventive concepts.

Although particular reference has been made to certain embodiments, variations and modifications are also envisioned within the spirit and scope of the following claims.

What is claimed is:

1. A Home Health Monitoring System comprising:
a security system for monitoring a building to detect intrusions into the building, and
uniquely identified motion sensors, with means to communicate remotely, located in each room of the building, and
a computer control station within the building receives signals from each motion sensor when anything moves within a motion sensor's range, and
each time a signal from a motion sensor arrives at the computer control station, a software program running on the computer control station stores in its computer system memory the motion sensor's identification and the time and date, and
a software program running on the computer control station accesses its memory periodically to compare the times of each motion sensor identification entry to each other

2. The system of claim 1, wherein said Home Health Monitoring System can compute a building occupant's path from room to room with date and time stamps for any movement inside of the building.

3. The system of claim 1, wherein said Home Health Monitoring System can compute a series of occupant's paths from room to room with date and time stamps to create a history of movement inside of the building.

4. The system of claim 1, wherein said Home Health Monitoring System, after computing a series of occupant's paths from room to room with date and time stamps to create a history of movement inside of the building can determine if the occupant's movement is typical for a given time.

5. The system of claim 1, wherein said Home Health Monitoring System, after computing a series of occupant's paths from room to room with date and time stamps, to create a history of movement inside of the building can determine if movement is not typical for a given time and thus generates a trigger event at which point an audible alarm is activated.

6. The system of claim 1, wherein said Home Health Monitoring System after computing a series of occupant's paths from room to room with date and time stamps to create a history of movement inside of the building can determine if movement is not typical for a given time and thus generates a trigger event at which point an audible alarm is activated and in which the occupant does not react to the alarm which triggers another event calling the preprogrammed alarm desk telephone number.

7. The system of claim 1, wherein said Home Health Monitoring System after computing a series of occupant's paths from room to room with date and time stamps to create a history of movement inside of the building can determine if movement is not typical for a given time and thus generates a trigger event at which point an audible alarm is activated and in which the occupant does not react to the alarm which triggers another event calling the preprogrammed alarm desk telephone number, and the operator at the alarm desk calls the occupant on the telephone.

8. The system of claim 1, wherein said Home Health Monitoring System after computing a series of occupant's paths from room to room with date and time stamps to create a history of movement inside of the building can determine if movement is not typical for a given time and thus generates a trigger event at which point an audible alarm is activated and in which the occupant does not react to the alarm which triggers another event calling the preprogrammed alarm desk telephone number, and the operator at the alarm desk calls the occupant on the telephone, and the occupant does not respond, and emergency personnel are dispatched to the occupant's building to assist them.

9. The system of claim 1, wherein said Home Health Monitoring System can be initialized to a preprogrammed number of minutes; for example, 0:15 to be stored in each time of day (TOD) table entry for use when the system is armed.

10. The system of claim 1, wherein said Home Health Monitoring System, after being initialized, can be placed into a learning mode which averages a preprogrammed number of days worth of occupant's paths from room to room inside of the building with date and time stamps thus modifying each time of day (TOD) table entry thus defining a typical path for when the system is armed.
